(19) United States
(12) Patent Application Publication
(10) Pub. No.: US 2006/0216395 A1
(43) Pub. Date: Sep. 28, 2006

(54) Food additives, foods and methods

(76) Inventor: Brian John Franklin, Neston (GB)

Correspondence Address: Robert C. Klinger;Jackson Walker, Suite 600, 2435 N. Central Expressway, Richardson, TX, 75044, US

(21) Appl. No.: 10/539,642

(22) PCT Filed: Dec. 12, 2003
(86) PCT No.: PCT/GB03/05429

§ 371 Date: May 18, 2006

(30) Foreign Application Priority Data
Dec. 17, 2002 (GB) 0229413.0

(51) Int. Cl. A23L 1/212; A23L 1/36

(52) U.S. Cl. 426/629; 426/615

(57) ABSTRACT

The invention provides a food additive composition comprising i) a bean powder, especially lima bean powder, ii) water absorbent vegetable fibre, iii) one or more inorganic calcium compounds, and iv) modified cellulose wherein the bean powder i) is present in a proportion of between 50 and 90% by weight based on the total weight of i), ii), iii) and iv). Foods comprising the additive composition and which are cooked or reheated in a microwave oven have generally improved characteristics such as taste and texture as compared to similar foods not comprising the additive.

The present invention relates to food additives for adding to processed foods, particularly, although not exclusively dough based foods, to be baked or fried and subsequently heated or cooked in a microwave oven. The invention relates to food products and to ingredients for food products, including foods comprising a core and a coating surrounding the core, for example a battered or breaded product. The invention also relates to foods or ingredients containing the food additives and method of improving the texture and characteristics of foods heated in a microwave oven.

Microwave ovens possess the ability to heat, cook or bake items, particularly foodstuffs, extremely rapidly. Unfortunately, microwave heating also has its disadvantages. For example, microwave heating alone often fails to achieve such desirable results as evenness, uniformity, browning, crispening, and reproducibility.

Processed baked or fried food products cooked or heated in a microwave oven seldom retain the characteristics of the same food cooked or heated in a convection oven. This is particularly so if the food product has been frozen or chilled.

Whereas in conventional cooking heat is applied from the outside, in microwave cooking heat is generated from within and the process can be very rapid and quite violent. A consequence of this is to rapidly convert some of the available water to steam during the microwave cycle. After heating the foodstuff “rests” during which period there is a release of water which can drip from the product. This is particularly noticeable for example when heating frozen food, especially that with a coating such as breadcrumb or including pastry, which foods can become soggy and unpalatable.

Attempts have been made to limit the escape of moisture during microwave cooking by coating the product with a composition adapted to form an impermeable film. These attempts have been unsatisfactory because the natural distribution of water within the coated product can be lost. Furthermore an impenetrable coating or film detracts from the taste and mouth feel of the product.

Accordingly the present invention provides in a first aspect a food additive composition comprising:
i) bean powder;
ii) water absorbent vegetable fibre;
iii) one or more inorganic calcium compounds; and
iv) modified cellulose,

wherein i) is present in an amount of between 50 to 90% by weight based on the total weight of i), ii), ii) and iv).

The food additive may also include other components, for example, added maltodextrins, proteins, herbs, spices or seasonings. Preferably, those other components will be present at less than 50% by weight based on the total weight of the food additive. The food additive, when added during the preparation of processed foods, allows such foods heated or cooked using a microwave oven to have properties more similar to the same such food when heated or cooked using a convection oven.

The inventor proposes that each of the constituents of the food additive composition homogeneously create an organic linkage upon processing the relevant food product. These organic linkages retard moisture migration from the core of the food product to the surface, thereby retaining the food product characteristics.

The food additive assists the functionality of the individual ingredient components of the food to which it is added. The following terms are used in the food industry to describe how to achieve the optimum product performance (the best quality end result):

For example with respect to doughs and batters, at the start of the production process the aim is to achieve a well defined homogeneous mass, i.e. all the respective recipe elements combined as one identifiable element, e.g. a good batter or dough reflecting each batter/dough's system characteristics such as high moisture absorption, free from gluten separation, starch complexing of the amylose and amylopectin elements, dough shortness and dough extensibility—gluten development and the emulsification of all of the elements.

To achieve the aforementioned characteristics the food industry has used many improvers and emulsifier systems which are chemically based. None of these systems is capable of retaining the characteristics of a baked or fried food that has been cooled and subsequently heated in a microwave oven.

The present invention provides a food additive composition made up from natural products which is capable of substantially retaining the characteristics of a baked or fried food to which it has been added and that has been cooled and subsequently heated in a microwave oven.

The starch/dextrins, dietary fibre (high in solubility), protein (non-gluten forming) and calcium carbonate help to provide the natural characteristics for well defined homogeneous mass, of high moisture absorption, free from gluten separation, starch complexing of the amylose and amylopectin elements, dough shortness and dough extensibility—gluten development and the emulsification of all of the elements.

Preferably, the bean powder is present at from 60 to 85%, more preferably from 80 to 90% by weight based on the total weight of i), ii), iii) and iv).

The bean powder component of the food additive composition of the present invention is a natural product which is preferably derived from the lima pulse. Lima bean powder is particularly preferred because of its bland taste and colour and also because it is a good source of soluble dietary fibre of a sticky or gum-like character, with bonding and moisture retaining properties. It provides fat, which is capable of absorbing carbohydrate, and protein which is able to form a complex matrix of organic linkages with the other constituents of the additive and the food to which it is added.

It is considered that other pulses such as broad, soya, haricot, mung, kidney, etc beans and chickpeas have too strong flavours or colours to be suitable for use in the food additive ingredient of the present invention. However they may be rendered suitable by chemical, genetic or enzymatic processing and if so processed are considered within the scope of the present invention.

The milled bean provides a fine powder with which preferably has a sieve analysis of 90% or over (preferably about 98%) through a 140 micrometer sieve.

The lima powder provides gummy characteristics to the food additive composition in use by providing a source of soluble fibre. Lima powder is low fat and high protein.

Lima bean powder as used in the composition of the present invention may be obtained from Arcadia Foods of Bradford, UK. Generally, the composition of lima powder comprises 11.6% moisture, 46.2% starch of which 3.6% is sugars, 19.1% is protein, 1.2% is fat and 21.5% is dietary fibre. Seasonal variations of up to 5% may occur.

The Arcadia Foods lima powder product comprises a total aerobic mesophilic count of 10000 CFU/g, yeasts at 500 CFU/g, moulds at 900 CFU/g and is free of E. coli and Salmonella.

The water absorbent vegetable fibre is a vegetable fibre which is capable of absorbing at least its own weight in water, for example, potato fibre. Preferably, the water absorbent fibre can absorb at least two, more preferably at least five times its own weight in water. The water absorbent vegetable fibre is preferably present at from 3 to 12%, more preferably from 4 to 10% and most preferably from 5 to 7% by weight based on the combined weight of i), ii), iii) and iv).

Potato fibre is a natural product which is derived from potatoes. Potato fibre provides the food additive with moisture absorbing properties as it is capable of absorbing up to 10 times its weight in moisture. It provides a drying function and is described as locking moisture.

Preferably, the potato fibre is a fine powder of fibre with a sieve analysis of 85% or over (preferably about 90%) through a 250 micrometer sieve.

Potato fibre powder suitable for use in the composition of the present invention may be obtained from Avebe of the Netherlands. Generally, the composition of potato fibre powder comprises 70-75% dietary fibre, 250 mg/g starch, 5% protein, 2% ash, 10 mg/kg sulphite and 50 mg/g moisture. The heavy metal content is 0.1 mg/kg arsenic, 0.05 mg/kg mercury, 0.5 mg/kg lead. Seasonal variations of up to 5% may occur.

The Avebe potato fibre powder product comprises a total aerobic mesophilic count of 100000 CFU/g, yeasts at 500 CFU/g, moulds at 1000 CFU/g and is free of E. coli and Salmonella. Preferably, the inorganic calcium compound is present at from 2 to 10% by weight based on the combined weight of i), ii), iii) and iv). The inorganic calcium compound may be a calcium salt or mineral. The inorganic calcium compound is preferably calcium carbonate. The calcium carbonate component may be crystalline calcium carbonate, preferably BM grade which is produced in the United Kingdom and may be obtained from Food Ingredient Technology Limited of Bedfordshire, UK.

The calcium carbonate is a firming element which enhances all of the functions of the other constituents of the food additive ingredient.

The modified cellulose component used in the food additive composition of the present invention is, for example, a natural product produced from vegetation and wood pulps as a free-flowing powder and may be obtained from Food Ingredient Technology Limited of Bedfordshire, UK. The modified cellulose should be at least partly soluble in water and is preferably completely soluble in water.

Modified cellulose is believed to complex with starch elements providing a contribution to the organic linkages between the constituents of the food additive and the food to which it is added. It also provides fat and moisture holding properties.

Preferably, the modified cellulose is present at from 0.5 to 10%, more preferably from 0.5 to 8%, most preferably from 1 to 4% based on the total weight of i), ii), iii) and iv).

The modified cellulose is preferably LIG 55 Methocel A4M food grade modified cellulose which satisfies the following industry standards:

Government/Industry standards EC—(European Community), FAO/WHO (Food and Agriculture Organisation/World Health Organisation), US FCC IV (Food Chemicals Codex), US FDA (Food and Drug Administration), US FDA 21 CFR 182.1480.

Test Requirements:

| Test Item | | | | |
|---|---|---|---|---|
| & Condition | Limit | Unit | Method | No |
| Methoxyl | 27.5-31.5 | % | Current FCC | |
| Viscosity 2% in | 3500-5600 | cPs | Current FCC | |
| water at 20° C. | 4000 norm | | | |
| pH, 1% in water | 5.0-8.0 | | DOWM 100668 | 1 |
| Loss on drying | 5.0 max | % | Current FCC | |
| Residue on ignition | 1.5 max | % | Current FCC | 2 |
| Arsenic | 3 max | ppm | Current FCC | 3 |
| Heavy metals (as Pb) | 10 max | ppm | Current FCC | 4 |
| Sulphiting agents | 10 max | ppm | AS FDA 21 CFR | 5 |
| (as Sulphur dioxide) | | | | |
| Cadmium | 1 max | ppm | ASTM D1976-91 | 6 |
| Lead | 5 max | ppm | ASTM D1976-91 | 7 |
| Mercury | 1 max | ppm | ASTM E181-93E1 | 8 |

Test requirement notes:

1. Test frequency=audit

2. Test frequency=audit

3. Test frequency=audit

4. Test frequency=audit

5. Test frequency=audit
Part 101, Appendix A. Monier-Williams procedure (with modifications) for sulphites in food, Centre for Food Safety and Applied Nutrition, FDA, November 1985.

6. Test frequency=audit

7. Test frequency=audit

The A4M product is certified Kosher for Passover and Pareve. The plant that produced the A4M product is registered under ISO 9002 Quality Systems. 100 grams of the A4M product has approximate nutrient values of 5 grams water, 1 gram sodium chloride and 15 milligrams iron. The A4M product meets all requirements outlined in 21 CFR 182.1480, the FCC for methylcellulose and the purity criteria set forth by the EC and FAO/WHO. When used within the EC, the label declaration E461 may be used.

The food additive composition may further comprise one or more added dextrins (some dextrin may also be present as a constituent of the bean powder). The addition of dextrins provides a further firming enhancer for particular circumstances and can also enhance the crispiness of a coating comprising the composition, for example, a coating on a meat product. Where dextrin is present it is preferably in an amount of no more than 50% by weight of the total weight of the additive composition.

Optionally, the composition also contains added non-gluten forming protein (apart from any protein present in the bean powder or vegetable fibre). Where present, the non-gluten forming protein will preferably be in an amount of not more than 50% by weight of the total weight of the additive composition.

A preferred composition of the food additive composition according to the present invention comprises 39% starch/dextrins, 3.1% reducing sugars, 26.6% dietary fibre high in solubility, 16.2% of protein (not gluten forming), 1.2% ash and 9.1% moisture. There are seasonal variations in the composition, which allow 5% variation from each of the above levels.

The food additive composition according to the present invention preferably provides the nutritional values of 17.5 g protein per 10 g product, 43.3 g carbohydrate per 100 g of product of which sugars constitute 3.2 g, 1.0 g fat per 10 g of product, 25.1 g fibre per 100 g of product and 60 mg sodium per 100 g product.

In a preferred embodiment, the food additive composition comprises 80-90% bean powder, 5-7% fine potato fibre, 3-5% calcium carbonate and 1-4% modified cellulose as active ingredients.

The food additive is particularly suitable for use with foods derived from cereals or pulses which are processed, baked or fried and then reheated or cooked. Optionally the food may be frozen or chilled prior to reheating or cooking.

The food additive may be used for all savoury and sweet processed foods, especially dough based foods and batters (both fermented and non-fermented), inclusive of potato doughs. The food additive may also be used for fillings, toppings, coatings or dustings of dough based foods, batters and potato doughs, including dry crumb coatings and the dusting of such doughs at specific processing steps.

As used herein, the expression “processed food” refers to food or a food component which has been processed in any way, for example, by milling, grinding, cooking or combining with other ingredients. Thus, raw uncut vegetables and unmilled cereals are not processed foods. Wheat flour, for example, is a processed food because it is produced by processing (milling) wheat.

A non-exhaustive and non-limiting list of processed foods which benefit from the use of the food additive according to the present invention includes pasta, puff pastry products such as pies, rolls and slices with both sweet and savoury fillings or toppings, bread, especially crusty bread products such as baguettes, loaves and rolls (including fillings), garlic bread, soft bread products such as fruited buns, hot dog rolls, burger buns, baps and naan bread, pitta bread, tortilla wraps and pizzas, both pizza bases or topped pizzas, batters for Yorkshire pudding, choux buns, various nuggets, fritters, crumpets, batters for cakes such as sponge cakes, and puddings, potato products such as roast potatoes, French fries, potato wedges waffles, potato croquettes and shaped potato products, baked or fried filo pastries such as spring rolls, samosas, parcels, morning goods including croissants, Danish pastries, doughnuts, including filled and topped doughnuts, shortcrust pastries, including pies and crumbles (with both sweet and savoury fillings), and bread crumb for coating for example for coating fish or meat, for example, chicken pieces or products, including shaped fish or chicken products such as fingers or nuggets.

The food additive composition may be added to base dough formulations at 0.5% to 5.0% (based on the weight of flour), to base batter formulations at 0.75% to 8.5% (based on the weight of flour), to base potato dough formulations at 0.5% to 3.0% (based on the weight of potato), to fillings/toppings at 1.0% to 5.0% (based on the weight of dry ingredients), or to subsequent dough processing steps at 0.1% to 1.5% (based on the weight of dry ingredients). Preferably, the above produce systems are baked or fried, then cooled frozen and packaged.

Except for the addition of the food additive composition as described above, the cooking (baking or frying) process may be otherwise conventional. The finished food thus produced is particularly suitable for the preparation of microwave heatable foods. To this end, the finished fast food may be wrapped with a microwave heatable packaging material and then stored or shipped in refrigerated or frozen storage for heating in microwave heater at home or in restaurants or shops or automated vending machines having a self-contained microwave heater to an optimum temperature without damaging the quality of food.

Alternatively, the food may be shipped as a frozen semi-finished product. Final cooking of this semi-finished product may conveniently be completed at home or in restaurants (including fast-food restaurants) or bakeries (including in-store bakeries) or shops, etc.

The packaging materials for wrapping finished fast food or semi-finished foods according to this invention must withstand or be adapted for microwave heating. Plastic laminates adapted for microwave heating are preferable for packaging the products to be sold by automated vending machines having a self-contained microwave heater in particular since the products are rapidly heated from frozen state to an elevated temperature.

The foods may be packaged in packaging utilising susceptor technology, that is using a device which, when disposed in a microwave energy field such as exists in a microwave oven, responds by generating a significant amount of heat. The susceptor absorbs a portion of the microwave energy and converts it directly to thermal energy which is useful for example to crispen or brown foodstuffs.

The absorption of microwave energy by the susceptor device reduces the amount of microwave energy available to cook the food. Simultaneously, the susceptor makes thermal energy available for surface cooking of the food by conductive or radiant heat transfer. Thus, susceptors tend to slow down direct microwave induction heating to provide some thermal heating which tends to be more uniform and provide such desirable results as browning or crispening.

Currently, the most commercially successful microwave susceptor is a thin film susceptor. Typically, thin film susceptors are formed of a thin film of metalised aluminium vacuum deposited on a polyester layer which is adhered to paper or cardboard.

Susceptors have been described in U.S. Pat. No. 4,640,838 issued to Isakson et al., U.S. Pat. No. 4,518,651 to Wolfe, Jr., and U.S. Pat. No. 4,959,516 issued to Tighe et al. Each of these susceptors and improvements thereto are suitable for use in packaging foods containing the food additive composition according to the present invention.

According to the present invention in a second aspect there is provided a processed food comprising:

i) bean powder;

ii) water absorbent vegetable fibre;

iii) one or more inorganic calcium compounds; and

iv) modified cellulose,

wherein i) is present in a proportion of between 50 to 90% by weight based on the total weight of i), iii), iii) and iv).

Preferably, the components i), ii), ii) and iv) are included in the food in the form of the food additive composition of the first aspect of the invention. However, they may, of course, be added separately to the food as long as they come into contact with each other within the food.

Preferably the processed food is a savoury or sweet food, especially dough based foods and batters (both fermented and non-fermented), inclusive of potato doughs. The food comprising the food additive may also be a filling, topping, coating or dusting of dough based foods, batters and potato doughs, including dry crumb coatings.

A non-exhaustive and non-limiting list of processed foods which benefit from the use of the food additive according to the present invention includes puff pastry products such as pies, rolls and slices with both sweet and savoury fillings or toppings, crusty bread products such as baguettes, loaves and rolls (including fillings), garlic bread, soft bread products such as fruited buns, hot dog rolls, burger buns, baps and naan bread, pitta bread, tortilla wraps and pizzas, both pizza bases or topped pizzas, batters for Yorkshire pudding, choux buns, various nuggets, fritters, crumpets, batters for cakes such as sponge cakes and puddings, potato products such as roast potatoes, French fries, potato wedges waffles, potato croquettes and shaped potato products, baked or fried filo pastries such as spring rolls, samosas, parcels, morning goods including croissants, Danish pastries, doughnuts, including filled and topped doughnuts, shortcrust pastries, including pies and crumbles (with both sweet and savoury fillings), and bread crumb for coating for example for coating fish or meat, for example, chicken pieces or products, including shaped fish or chicken products such as fingers or nuggets.

The food may comprise the food additive composition at 0.5% to 5.0% for base dough formulations, at 0.75% to 8.5%, for base batter formulations, at 0.5% to 3.0% for base potato dough formulations, at 1.0% to 5.0% for fillings/toppings or is added during subsequent dough processing steps at 0.1% to 1.5%. Preferably, the above produce systems are baked or fried, then cooled frozen and packaged.

In one embodiment the components i), ii), iii) and iv) are present in a coating on the surface of the food, such as a batter or crumb coating. In a further embodiment, those components may be present in a filling of a food. In a yet further embodiment, those components may be present throughout the food.

It would be convenient to provide a premix for making the microwave heatable processed foods as describe above at home or in bakery shops. Such a premix comprises a food additive composition according to the first aspect of the invention, in combination with a base ingredient of a processed food.

A preferred premix comprises 0.5 to 9% of the food additive composition according to the first aspect of the invention. Preferably the base ingredient is flour, especially wheat flour. The flour premix may optionally contain an effective amount of a system for leavening (e.g. yeast, enzymes and raising agents) and may also include fats, sugar, and flavour as required.

According to a further aspect of the invention there is provided a method of preparing processed foods for heating or cooking in a microwave oven, the method comprising incorporating into a food or ingredient for a food a suitable amount of i), ii), iii) and iv). Preferably, those components are added in the form of the food additive ingredient according to the first aspect of the invention.

A suitable amount of food additive composition is preferably 0.15 to 10% depending on the food product.

The food additive composition may be added to base dough formulations at 0.5% to 5.0%, to base batter formulations at 0.75% to 8.5%, to base potato dough formulations at 0.5% to 3.0%, to fillings/toppings at 1.0% to 5.0%, or to subsequent dough processing steps at 0.1% to 1.5%. Preferably, the above produce systems are baked or fried, then cooled frozen and packaged.

For example, the food additive composition according to the first aspect of the invention may be added to the ingredients used to make doughs or batters. The doughs or batters are then processed according to standard methods. The food additive composition may be capable of increasing the recovery time after mixing or accelerating the fermentation time to provide an optimum structure.

In a yet further aspect, the invention provides the use of i), ii), iii) and iv) in admixture in a food which is processed or cooked, stored and then cooked or reheated, to improve the texture of the cooked or reheated food.

With regard to the use of the invention for preparing the processed foods an example of how the food additive composition may be having its effect is described in relation to wheat flours. The typical moisture content of wheatflours is 13%-14%, with seasonal variations. Approximately 6% of the respective moisture content is known as locked in moisture, as opposed to the balance known as free moisture.

Moisture added as part of a particular product's recipe is free moisture. Free moisture is defined as easily removed from the baked/fried, frozen or chilled product microwaved in an oven.

Locked in moisture is naturally occurring and can be enhanced significantly through the addition of the food additive in accordance with the present invention to the base recipe and dusting with the food additive also. The food additive provides protein and soluble dietary fibre which has preferably the properties of absorbing up to ten times its weight of moisture which is complexed throughout the baked/fried, structure/texture of the respective product. Locked in moisture is defined as difficult to remove compared to free moisture. Therefore when the referred to foods are frozen the resulting complexing of the food additive of the present invention holds the ice crystals in a revised formation to that without the food additive.

In the normal method of preparing processed foods such as bread, the mechanical development of batters and doughs creates a homogeneous mass but the starch components of the batter or dough are altered from their normal characteristics and require a resting period for starch retrogradation within the homogeneous mass. The inventor proposes that the food additive composition is capable of enhancing starch retrogradation, its natural reducing sugars aiding any fermentation and the soluble fibre, ash and protein providing additional body and moisture holding properties to the structure of batters and doughs.

The rested, recovered, fully retrograded doughs may be processed accordingly for the relevant product. For example, bread fermented doughs may be scaled and moulded into their ultimate form, optionally being lightly dusted with the food additive composition in the process and set to prove prior to the next process step.

With non-fermented doughs, e.g. puff pastry, short pastry, and fermented doughs such as croissants and Danish pastries the doughs may be processed to receive traditional fats and butters at the point of initial folding. Subsequent folding or the equivalent may include dusting with the food additive composition according to the first aspect of the invention. Preferably the products are dusted top and bottom and folded accordingly or laminated, functionally creating a textural and moisture retaining film between layers of dough containing butter/fat, which is thereby held in the subsequent bake off and microwave heating of the products by the soluble fibre, ash and protein matrix formed by the food additive composition according to the first aspect of the invention.

Once the desired fold or laminations of the respective doughs have been completed and sheeted for the relevant product the sheets are optionally dusted with the food additive composition according to the first aspect of the invention. Preferably the dough is processed to a sheet thickness of 3 mm to 4 mm. Mechanical recovery, retrogradation of the starches/homogeneous mass is required to achieve the optimum product quality. The food additive composition according to the first aspect of the invention assists in recovery.

Products may be formed, with or without sweet or savoury fillings, including the food additive composition according to the first aspect of the invention to retain moisture and prevent final product wetting or greasiness, via the holding properties of the food additive composition.

Formed fermented products may be lightly dusted with the food additive composition according to the first aspect of the present invention before setting to prove. Post proof the products may be washed appropriately for bake off or frozen for subsequent bake off.

Formed non-fermented products may be lightly dusted with the food additive composition according to the first aspect of the present invention and set for bake off and washed appropriately, or frozen for subsequent bake off.

For fermented goods proof temperatures generally range from 32 to 35° C. for up to 50 minutes. When using the food additive composition according to the first aspect of the invention, as a dough ingredient and as a dusting, higher proving temperatures of 40 to 50° C. may be used, and the proving time reduced to 25 to 30 minutes.

For the purpose of this specification a chilled product is held at slightly above freezing, for example, at from 1 to 5° C. and a frozen product is held at below freezing, for example, at about −18° C.

The invention will now be further described by the following non-limiting examples.

### EXAMPLE 1

Production of Food Additive X

To prepare a test batch:

Food additive X according to a preferred embodiment of the present invention was prepared by mixing 2000 grams lima powder obtained from Arcadia Foods of Bradford, UK under catalogue number FL00011, with 140 grams potato fibre material no 9679 obtained from Avebe of the Netherlands with 100 grams of modified cellulose (catalogue number A4M) and 100 grams of calcium carbonate (code BM), both obtained from Food Ingredient Technology Limited of Bedfordshire, UK, at 25 degrees centigrade and atmospheric pressure in a Hobart blender for 5 minutes.

The homogeneous composition produced was termed food additive X.

On a commercial scale 300 kg of lima powder, 22 Kg potato fibre, 17.5 Kg calcium carbonate and 17.5 Kg modified cellulose (all as described above) were mixed in a Gardner blender at 25 degrees centigrade and atmospheric pressure for 5 minutes to produce a homogeneous mixture.

### EXAMPLE 2

Production of Processed Foods

1. Puff Pastry Products Including Pies, Rolls and Slices, Both Savoury and Sweet

Product types—sausage rolls, meat pies, pasties all, slices, mincemeat pies, apple puffs, jam puffs/pies etc.

In the respective fillings food additive X is added at 1% to 1.5%.

Typical puff pastry dough commercial recipe including food additive X:

| | | |
|---|---|---|
| Strong Flour | 80 | kg |
| Pastry Fat | 3 | kg |
| Salt | 0.5 | kg |
| Cream of Tartar | 0.1 | kg |
| Food additive X | 0.8 | kg |
| Water | 50 | Litres |

All in dough method. Mix to a firm smooth dough. Scale dough into 9 kg pieces 3 kg to 4 kg pastry fat. Break/pin into rectangle sheets. Place puff pastry fat system into centre of rectangle sheet. Fold fat in and conventionally break/pin to achieve 2 book turns. Rest for 30 minutes. Break/pin, Dusting with food additive X reducing sheet thickness gradually to 3 to 4 mm thickness to achieve double book turns. Break/pin sheeted and dusted with food additive X for formation of product type. Rest for 20 minutes.

Formed product cuttings/scrap up to 25% introduced post first rest period thereby subsequently folded in.

When processing pastry dust with 1.5% food additive X per book 1.5%.

Savoury products, sprayed with egg glaze. Sweet products sprayed with water and sugar dusted. Rested for 30 minutes prior to bake or frozen down for subsequent bake. Bake hot oven, even heat at 190° C. to 220° C. Baked products chilled and wrapped or frozen and wrapped into outer cases.

2. Crusty Breads

Product types—baguettes, garlic bread, crusty rolls

Typical crusty bread recipe including food additive X:

| | | |
|---|---|---|
| Strong Flour | 180 | Kg |
| Vegetable oil | 7.2 | Kg (olive oil for garlic bread) |
| Salt | 1.69 | Kg |
| Food Additive X | 2.5 | Kg |
| Yeast | 3.0 | Kg |
| Improver | 1.0 | Kg for baguettes only |
| Garlic Granules | 1.125 | Kg for garlic bread only |
| Water | 115 | Litres |

All in dough method. Dough piece weights 150 g baguettes and garlic bread, 50 g crusty rolls. Moulded and set for fermentation 1 hour.

Dough pieces knocked back and moulded into appropriate shape, dusting with food additive X. Moulded and shaped dough pieces placed into/onto prepared bakeware, and dusted with food additive X. Moulded dough pieces surfaces scored as appropriate and a light surface dusting of food additive X applied.

Conventional proofing 30 minutes to 45 minutes as appropriate for the particular product.

Good Bake 220°/230° C. for top and bottom crust development 30 minutes to 45 minutes as appropriate for the particular product and oven performance.

Baked weights: baguettes/garlic bread 115 g, rolls 38 g.

Breads cooled, cut and filled. Chilled and wrapped or frozen and wrapped into outer cases.

3. Soft Breads

Product types—fruited buns, hot dog rolls, burger buns, baps, naan breads, hot cross buns.

Typical Soft Bread recipe including food additive X

| | | |
|---|---|---|
| Strong Flour | 48 | Kg |
| Salt | 0.4 | Kg |
| Yeast | 0.1 | Kg |
| Sugar | 1.0 | Kg |
| Milk solids | 0.5 | Kg |
| Food Additive X | 0.8 | Kg |
| Water | 28.0 | Litres |
| Fat | 7.5 | Kg |
| Mixed fruit | 3.5 | Kg (fruited products only) |

All in dough method (except fruit). Dough piece weights 55 g plain rolls, buns, baps, 40 g Fruited Buns.

Moulded and set for fermentation for 1 hour.

Dough pieces knocked back and moulded into the appropriate shape and dusted with food additive X. Moulded and shaped dough pieces placed onto prepared bakeware and a light dusting of food additive X applied.

Conventional proofing 30 minutes to 40 minutes as appropriate for the particular product.

Baking at 220°/230° C. even heat for 15-20 minutes as appropriate for the particular product. Approximate baked weights 45 g plain rolls, buns, baps, 32 g fruited buns.

Breads cooled, cut and filled then chilled and wrapped or frozen and wrapped into outer cases.

4. Batters

Product types—Yorkshire puddings, choux pastry, chicken nuggets etc., crumpets.

Typical batter recipes including food additive X

| Fermented | Kg | Ambient/Boiled | Kg | Coating | Kg |
|---|---|---|---|---|---|
| Flour | 10 | | 10 | | 10 |
| Yeast | 0.280 | | — | | — |
| Milk solids | 0.350 | | 0.770 | | 0.500 |
| Water | 12.5 | Litres | 15.3 | | 16.500 |
| Baking Soda | 0.01 | | — | | — |
| Salt | 0.110 | | 0.180 | | 0.180 |
| Food | 0.250 | | 0.250 | | 0.500 |
| additive X | | | | | |
| Whole Egg | — | | 5.770 | | — |
| Polenta | — | | — | | 1.700 |

Liquids blended together, dry materials vortexed in to form smooth batters. Batters rested and fermented accordingly.

Deposited in traditional manner into bakeware or rings and given a light surface dusting with food additive X. Protein meats dusted with food additive X e.g. rolled or tossed prior to coating with batter.

Baking: Fermented, ambient, boiled batter product types e.g. crumpets, Yorkshire puddings, choux pastries are lightly dusted with food additive X and baked traditionally. Coating batters are deep fat fried e.g. chicken, fish etc. at 185° C. for 1 minute 30 seconds maximum.

Products chilled and wrapped, frozen and wrapped into outer cases.

5. Potato Products

Product types—roasties, fries, waffles, croquettes, shapes

Typical recipe for potato products with food additive X

| | |
|---|---|
| Freshly steam cooked potatoes - Mashed | 100 kg |
| Food additive X | 4 kg |

Mix to dough. Suitable forming techniques include extruding shapes for the aforementioned products and shapes. Post forming the potato dough pieces are lightly dusted with food additive X. They are then baked to achieve the desired textural solids for the appropriate product via temperature profile.

Products are chilled and gas flushed, wrapped or frozen and wrapped for outer case packaging or baked products are hot oil blanched 180/185°, chilled and gas-flushed, wrapped or frozen and wrapped for outer packaging.

6. Filo Pastries

Products types—spring rolls, parcels, samosas

Typical filo pastry recipe including food additive X

| | | |
|---|---|---|
| Strong Flour | 100 | Kg |
| Food additive X | 2 | Kg |
| Water | 110 | Litres |
| Cream of Tartar | 0.1 | Kg |

All in mixing method to well developed dough and rested for ½ hour.

Dough is sheeted through series of reducing rolls. The dough being lightly dusted with food additive X and reduced to a dough thickness of approximately 0.4 to 0.7 mm and protected from drying out.

Respective traditional fillings are prepared for spring rolls, parcels, samosas etc. with the addition of 1 to 1.5% food additive X by weight.

For baked varieties sheeted dough is dusted with food additive X and cut into strips to suit the formation of the appropriate products. The strips are lightly sprayed with hot oil or butter and correctly positioned filling deposits. The products are formed by rolling rolls, folding and crimping accordingly. The products are surface oil sprayed and trayed/panned and baked in a hot oven at 220/220° C. until golden brown.

For hot oil blanched products, sheeted dough with food additive X rolled into the surface is hot oil blanched 180/185° C. to achieve a malleable par cooked sheet and cut into strips and formed into shapes with the appropriate fillings. Low oil uptake is observed when using the food additive ingredient.

Products form both the baked and blanched processes are cooked and wrapped or frozen and wrapped and then packaged into outer cases.

7. Morning Goods

Product types—croissant family of products, Danish pastries, etc

Typical recipe including food additive X

| | | |
|---|---|---|
| Strong Flour | 5.600 | Kg |
| Salt | 0.030 | Kg |
| Improver | 0.200 | Kg |
| Sugar | 0.425 | Kg |
| Vegetable fat | 0.425 | Kg |
| Yeast | ¼ | slab |
| Food additive X | 0.075 | Kg |
| Water | 3.000 | litres |

All in dough mixing method to produce a well developed dough. Fermentation is for 1 hour. Process 10 Kg dough, with 2.75 Kg flattened block butter fat. Processed 4 Book folds through pastry break. The final 2 folds being dusted with food additive X. The product is rested between each 2 folds for 20 minutes and final folds rested 30 minutes.

Pastry blocks sheeted to approximately 3 mm thickness dusting with food additive X top and bottom.

Croissants are formed by cutting sheeted dough into 200 mm squares then into triangles and moulded to form wrap around croissant shapes. Shapes panned into surface lightly dusted with food additive X. Surface dusted and proofed for 40-45 minutes. The product are sprayed with egg glaze prior to baking at 200° C. for 20 minutes.

Danish pastries are formed by sizing, crimping and surface scoring slices, Danish squares etc. Fillings can include fruit, almond butter or sugar paste, with 1% food additive X added. Product surfaces embellished with bake stable ingredients—flaked almonds, nibbed sugar etc. Panned onto lightly dusted surface and product surface lightly dusted with food additive X and proofed for 40-45 minutes.

Products are sprayed with egg glaze prior to baking at 200° C. for 20 minutes then allowed to cool and wrapped, frozen and wrapped to outer cases.

8. Doughnuts

Typical Doughnut recipe including food additive X

| | | |
|---|---|---|
| Strong Flour | 10 | Kg |
| Doughnut concentrate | 2.5 | Kg |
| Yeast | 0.625 | Kg |
| Food additive X | 0.150 | Kg |
| Water | 4.75 | Litres |

All in dough mixing method to provide a well developed dough. Fermentation is for 1 hour. Then dough divided to 60 g pieces. Dough pieces moulded with light dusting of food additive X. Pieces placed onto sheets of webbing dusted with food additive X. 45 Minutes proof, stand out for 20 minutes to skin over.

Doughnut web sheets connected to continuous feed mechanism. Proofed doughnut pieces are fed into fryer with vegetable oil temperature 188° C. Fry time 3 minutes. Turnover at 1½ minutes. From Fryer doughnuts are stood to stabilise prior to filling with for example jam, banoffee, peanut, chocolate, etc. All fillings have the addition of 1% to 1½% food additive X by weight.

Produced are cooled and wrapped, frozen and wrapped into outer cases.

The food additive X gives shelf life extension to fresh doughnuts

Freshly made doughnuts have a limited shelf life—maximum 8 hours.

With food additive X the natural shelf life is extended to 3 days.

Within protective polythene packaging, test satisfactory at 5 days.

9. Short Paste Crust Pastries

Product types—mince pies, apple pies, custard, crumble—all varieties of fruit applicable Typical short paste crust recipe including food additive X

| | | |
|---|---|---|
| Flour | 140 | Kg |
| Vegetable fat | 35 | Kg |
| Cake Margarine | 35 | Kg |
| Sugar | 35 | Kg |
| Vanillin | 0.1 | Kg |
| Food additive X | 12 | Kg |
| Water (very cold) | 10 | Litres |

Fats, sugar, water and flavouring are creamed together. Flour and food additive X blended through to form short dough.

Note: For crumble toppings the flour weight is increased to 210 kg. Method of mixing as above.

Pastry bases are formed via pie case pressing machinery. Fillings are applied via depositor. To prepare top pastry lids shortcrust dough is sheeted and dusted with food additive X top and bottom to a dough thickness approximately 3 mm. Dough sheets are cut to the appropriate size and positioned over the filled bases or crumble crumbed. Products are baked at 170/180° C. for time to suit the appropriate product.

Cooked products are cooled and wrapped, frozen and wrapped into outer cases.

10. Bread Crumb

Product types—crumb for coating proteins e.g. fish, chicken, etc.

Typical recipe for crumb including food additive X

| | | |
|---|---|---|
| Bread Flour | 15.000 | Kg |
| Food additive X | 3.800 | Kg |
| Vegetable fat | 3.000 | Kg |
| Yeast | 0.400 | Kg |
| Salt | 1.400 | Kg |
| Sugar | 0.700 | Kg |
| Water | 9.500 | Litres |

All in mixing method, mix to well developed dough. Fermentation is for 1 hour.

Scaled at 1 kg dough pieces and moulded for loaves, with a dusting of food additive X. Proofed for 50 minutes.

Dough is par bake in hot oven 200° C. for 30 minutes (light surface colour) then rapid cooled to achieve long stability.

Loaf/loaves shredded crumbed and lightly dusted with food additive X. Tumble mixed and conditioned for 1 hour then hot air rapid dried, to 5% moisture. The crumb is then cooled and bagged off.

Various coatings may be applied.

11. Cakes, Sponge Cake, Sponge Cake Puddings

Product types—Fruited cakes and puddings, chocolate/caramel/fudge cake or puddings, jam sponge & other soft fruit cakes or puddings.

In the respective fillings food additive x is added at 1 to 1.5%.

Typical basic cake/sponge cake/pudding commercial recipe including food additive X:

| | | |
|---|---|---|
| Cake shortening/fat | 15 | Kg |
| Sugar | 12 | Kg |
| Egg whole liquid | 20 | Kg |
| Flour | 12 | Kg |
| Cornflour | 6 | Kg |
| Raising agent | 0.250 | Kg |
| Food additive X | 0.950 | Kg |

Method of mixing is subject to the cake style required. Suitable methods include the sugar batter method, flour batter method and all in method. The recipe is adapted with flour and moisture as appropriate and may be adapted to provide structural holding properties e.g. to allow the inclusion of fruits.

12. High Protein Foods and Products Comprising Vegetables.

High protein foods (such as cuts and joints of meats such as chicken and other fowl, fish, pork, beef and lamb and cheeses) and products comprising vegetables (such as wedges, roasted vegetables, gratins and hash browns prepared from potatoes, yams and sweet potatoes, and cut pieces of onions, carrots, cauliflower, parsnips, swedes and peppers), are processed according to methods i), ii) or iii) described below

Method i)

The product, for example a pork cutlet or a carrot finger is coated with 1.5 to 5% additive X by weight based on the weight of the product to give a coated product.

Method ii)

The product is treated according to method i) and is then coated with 20% to 30% by weight of batter based on the weight of the product to give a coated, battered product.

Method iii)

The product is treated according to method ii) and is then coated with 17.5 to 27.5% crumbs by weight based on the weight of the product to give a coated, battered and crumbed product.

If desired, the coating applied in method i) may include non-active ingredients to provide flavour. For example, where a savoury product is desired, the coating may be a savoury coating including seasoning or spices. Typically, the food additive X is added to the high protein food or vegetable containing food at 1.5 to 5% by weight based on the weight of the high protein food or vegetable containing food. A typical savoury mixture (which can be a dry coating or a liquid batter, as desired, by adjusting the water content) is:

Kg

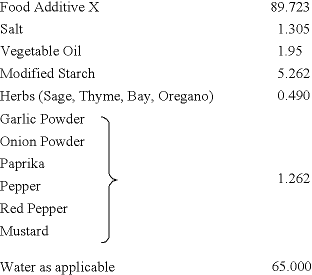

The above ingredients are mixed together to form a fully dispersed fine crumb which is applied to the appropriate high protein food or vegetable containing food by dusting using a continuous rotary drum coating unit.

For a liquid coating, the slurry/batter is applied using a dribble pulse pump onto the high protein food or vegetable containing food within the continuous rotary coating unit.

Coated foods prepared according to method i) are chilled or frozen and then packed into microwave susceptor materials.

Coated/battered products prepared according to method ii) are flash fried in oil at 170 to 200° C. for 40 seconds to 1 minute prior to being chilled and frozen and packed into microwave susceptor materials

Coated/battered/crumbed products prepared according to method iii are oven baked for approximately 7 minutes or flash fried at 170 to 200° C. for 40 seconds to 1 minute, chilled or frozen and then packed into microwave susceptor materials.

13. Pasta Products:

Pasta is typically made from Durum wheat semolina.

Steps—Method of Manufacture

1 to 5 wt % food additive X is added to Durum wheat semolina and is conventionally processed via cooking with water whilst applying shear. The levels of additive X will vary according to the type of pasta being processed, a) dried for ambient sale, b) fresh/chilled pasta or c) fresh frozen pasta. Additive X is believed to aid starch complexing within the mass matrix and thereby subsequent moisture retention.

The Pasta Products are Cooked as Follows:

a) Dried pasta is mixed with water and cooked in a microwave oven.

b) Fresh chilled pasta is heated in a microwave oven.

c) Fresh frozen pasta is heated in a microwave oven.

14. Bread Products:

All types including sliced wrapped, pizza, bagels, sandwiches, toast, and toasted sandwiches. Additive X is added at 1 to 6% by weight based on the weight of flour.

Typical Bread Recipe Formation

| Regular | Kg | Long Life | Kg |
|---|---|---|---|
| Bread Flour | 180 | Bread Flour | 180 |
| Salt | 3 | Salt | 3 |
| Improver | 2 | Special Improver | 4.2 |
| Additive X | 2 | Additive X | 2.5 |
| Fat | 0.5 | Fat | 0.5 |
| Liquid Yeast | 3.4 | Liquid Yeast | 6.2 |

Method: All components are mixed to a homogenous dough mass. The dough was scaled into approximately 900 g portions for the standard 800 g large loaf of bread and was moulded into round spheres. The dough portions are given 10 to 15 minutes recovery fermentation prior to being moulded and tin panned.

Proof: Moist air temperatures range from 35° C. to 50° C. and the duration of proof is 45 to 50 minutes.

Baking: in continuous oven set temperatures are 250° C. to 275° C. Bake time is approximately 25 to 30 minutes.

Baked sandwich loaves are de-panned via suction. The loaves with additive X showed an improved performance. The loaves are transferred to a continuous cooling chamber and cooled for 2 hours prior to being conveyed to slicing and wrapping machinery and placed in trays.

Fresh Bread: comparison with and without Additive X. With Additive X an improved surface appearance is obtained. The inner structural texture is more even, and the resulting eating sensation is somewhat lighter to the palate.

Frozen Bread: Comparison with and without Additive X. Respective loaves are removed from the freezer and are allowed to thaw overnight for approximately 10 hours.

The defrosted bread is made into i) sandwiches ii) toast which is then buttered and iii) toasted sandwiches eg smoked ham and cheese.

Slices of bread or toasted bread with Additive X and spread with butter are resilient to spreading pressure compared to bread without Additive X in which the inner structure collapsed, yielding a more doughy textural eat, versus the crisp light melt away texture of bread with Additive X.

After 5 days the bread with Additive X retains its freshness and the characteristics of the prepared products described above, whereas bread without additive X had staled rapidly after day 1 because of the damage to structure caused by freezing and the resulting loss of moisture.

15. Batters:

From frozen—Cakes, cakes fruited, sponges, sponge puddings e.g. chocolate, syrups, fruited, rich fruited e.g. Christmas puddings, Yorkshire puddings, choux buns and pastries.

Additive X is added at 1.5 to 10% by weight to the respective batter based on the weight of the flour. Batter types are deposited into the appropriate microwave baking utensil, frozen and wrapped.

Typical Batter Recipe for Sponge Cake or Puddings

| | Kg |
|---|---|
| Flour | 108 |
| Pulverised sugar | 130 |
| Cocoa A16 | 25 |
| Cornflour | 15 |
| Food Additive X | 17 |
| Baking Powder | 10 |
| Chocolate Enhancer | 2 |
| Milk Solids | 5 |
| Butter Powder | 27 |
| Rice Flour | 7 |
| Admal 2230 | 5 |
| Vanillin | 0.113 |
| Pumpable Shortening | 27 |
| Liquid Eggs | 140 |
| Water | 130 |

Mixing Method: All dry ingredients including shortening are blended and then the liquids are added. The mixture is blended to form a well-mixed batter. 100 g to 125 g batter is deposited into microbake utensils, frozen, wrapped and packaged.

### EXAMPLE 3

Test of Effectiveness of Food Additive X

The following examples compare the product performance of products containing food additive X made in example 1 with products not containing the food additive.

Using a microwave oven at 800 watts on full power for the time appropriate for the product, starting with either chilled or frozen product.

1. Puff Pastry Products Including Pies, Rolls and Slices, Both Savoury and Sweet

With food additive X made in accordance with Example 1: From the microwave oven and allowed to stand for at least 3 minutes to provide stabilisation and the correct consuming temperature. The surfaces tops, sides and bottoms are dry, firm and crisp to the touch. They retain their thermal processed appearance. The initial bite or cutting off of a piece of the product reveals crispness, or the expected textural structure and eating sensation of a product from the conventional thermal oven.

Without food additive X made in accordance with Example 1: From the microwave oven and allowed to stand for 3 minutes to provide the correct consuming temperature. The surfaces, tops, sides and bottoms are collapsed, wet and greasy to the touch. The product is unstable to handle. The initial bite or cutting off of a piece of the product is soft, chewy and leathery revealing the collapse of the textural structure.

2. Crusty Bread Products Including Filled Baguettes, Garlic Bread and Crusty Bread and Rolls

With food additive X made in accordance with Example 1: From the microwave oven and allowed to stand for at least 3 minutes to provide stabilisation and the correct consuming temperature. The surfaces, tops, sides and bottoms are dry, firm and crisp to the touch and retain their thermal processed appearance. The initial bite or cutting off of a piece of the product reveals crispness, a moist inner retained crumb structure and an eating sensation of a product from the conventional thermal oven.

Without food additive X made in accordance with Example 1: From the microwave oven and allowed to stand for 3 minutes to provide the correct consuming temperature. The surfaces, tops, sides and bottoms are damp and malleable to the touch. The initial bite or cutting off of a piece of the product feels leathery revealing a significant collapse of the crumb structure and a texture that becomes increasingly chewy to the point of dry hardness.

3. Soft Bread Products Including Fruited Buns, Hot Dog Rolls, Burger Buns, Baps and Naan Bread

With food additive X made in accordance with Example 1: From the microwave oven and allowed to stand for at least 3 minutes to provide stabilisation and the correct consuming temperature. The surfaces, tops, sides and bottoms are dry and firm to the touch and retain their initial appearance. The initial bite or cutting off of a piece of the product reveals a thin outer skin/crust and a soft moist structure of the same textural characteristic, depicting the eating sensation of products from the conventional oven.

Without food additive X made in accordance with Example 1: From the microwave oven and allowed to stand for 3 minutes to provide the correct consuming temperature The surfaces, tops, sides and bottoms are damp and concave resulting from a collapsed inner structure. The initial bite or cutting off of a piece of the product is tough, elastic like with a textural mouth feel of chewiness and progressively to the point of dry hardness.

4. Batters Such as for Yorkshire Pudding, Choux Buns, Various Nuggets and Crumpets

With food additive X made in accordance with Example 1: From the microwave oven and allowed to stand for at least 3 minutes to provide stabilisation and the correct consuming temperature. The surfaces, tops, sides and bottoms are firm to the touch, and of original appearance. The initial bite or cutting off of a piece reveals the retention of structural formation and textural mouth feel sensation as if direct from the conventional thermal baking oven, fryer or hot-plate.

Without food additive X made in accordance with Example 1: From the microwave oven and allowed to stand for 3 minutes at least to provide the correct consuming temperature. The surfaces appear shrivelled, tops, sides and bottom soft to the touch and collapsing. The bite or cutting with a knife will give a leathery sensation caused by the collapsing structure, the texture chewy and cloying to the palate.

5. Potato Products Such as Roasties, Fries, Waffles, Croquettes and Other Shaped Potato Products

With food additive X made in accordance with Example 1: From the microwave oven and allowed to stand for at least 3 minutes to provide stabilisation and the correct consuming temperature. The surfaces, tops, sides and bottoms are dry (not greasy) and firm to the touch with their retained original appearance. The initial bite or cutting a piece off with a sharp knife reveals an outer skin having characteristics similar to those obtained by bake/roasting, grilling or frying together with a good inner structure and texture as appropriate to the conventionally prepared product.

Without food additive X made in accordance with Example 1: From the microwave oven and allowed to stand for at least 3 minutes to provide the correct consuming temperature. The surfaces, tops, sides and bottoms are greasy wet and soft to touch. The product has impinged (collapsing) within the inner structure. The initial bite or cutting off of a piece of the product has a soft chewy skin and inner texture of differing degrees, which is particular to the type of product being prepared.

6. Filo Pastries Including Baked or Fried Goods Such as Spring Rolls, Samosas, and Parcels

With food additive X made in accordance with Example 1: From the microwave oven and allowed to stand for at least 3 minutes to provide stabilisation and the correct consuming temperature. The surfaces, tops, sides and bottoms are dry, not greasy, firm to the touch and of retained appearance of thermal processing. The initial bite or cutting off of a piece of the product reveals crispness, retained structure and a moist inner filling, which eats as if prepared in a conventional thermal process—ovening or frying.

Without food additive X made in accordance with Example 1: From the microwave oven and allowed to stand for at least 3 minutes to provide the suitable eating temperature. The surfaces, tops, sides and bottoms are crinkled, soft, wet/greasy and unstable to the touch. The initial bite or cutting off of a piece of the product is similar to a toughening wet pasta i.e. the structure having collapsed, with a texture that is soft, chewy and dough-like (somewhat cloying).

7. Morning Goods Including the Croissant Family of Products and Danish Pastries

With food additive X made in accordance with Example 1: From the microwave oven and allowed to stand for at least 3 minutes to provide stabilisation and the correct consuming temperature. The surfaces, tops, sides and bottoms are dry, not wet or greasy, firm to the touch and of retained appearance of thermal conventional baking. The initial bite or cutting off of a piece of the product reveals the expected structure of conventional baking and eating texture of freshness direct from the oven.

Without food additive X made in accordance with Example 1: From the microwave oven and allowed to stand for at least 3 minutes to provide the suitable eating temperature. The surfaces, tops, sides and bottoms are soft, wettish, greasy to the touch and unstable to handle. The initial bite or cutting off of a piece of product is difficult due to the collapsed inward structure and elastic leathery surfaces. Texturally the eat is chewy and cloying, which is unpleasant, and unacceptable.

8. Doughnuts of All Varieties.

The effect of freshness within 1 hour of manufacture

With food additive X made in accordance with Example 1: From the microwave oven and allowed to stand for at least 3 minutes to provide stabilisation and the freshly made doughnut consuming temperature. The surfaces, tops, sides and bottoms are dry and not greasy, reasonably firm to the touch and of retained appearance from the fryer and filling operation (normally jam). At this point they are sprinkled with caster sugar. The initial bite or cutting off of a piece of product reveals surface and retained structure expected of a conventionally prepared food with the filling (jam) in its deposited position. Textural properties are light and moist to eat, delivering the freshly made doughnut experience.

Without food additive X made in accordance with Example 1: From the microwave oven and allowed to stand for at least 3 minutes to establish the freshly made doughnut consuming temperature. The surfaces, tops, sides and bottoms are soft to the touch and difficult to handle i.e. poor shape retention. At this point they are sprinkled with caster sugar. The initial bite or cutting off of a piece of product caused the inner structure to collapse, the crumb formation is lost, it welds together like dough. The eating sensation resembles the appearance—dough-like, cloying and too chewy.

9. Shortcrust Pastries Including Meat Pies, Mincemeat Pies, Apple Pies Etc and Various Crumbles

With food additive X made in accordance with Example 1: From the microwave oven and allowed to stand for at least 3 minutes to provide stabilisation and the correct eating temperature. The surfaces, tops, sides and bottoms are dry, not greasy, reasonably firm to the touch and of retained appearance from the conventional thermal oven. The initial bite or cutting off of a piece of the product has the characteristic “sound” of textured shortness through the crusting. Texture is short but non-cloying.

Without food additive X made in accordance with Example 1: From the microwave oven and allowed to stand for at least 3 minutes to cool to the correct eating temperature. The surfaces, tops, sides and bottoms are soft, damp, greasy to the touch and unstable to handle. The initial bite or cutting off of a piece of the product is difficult as it has become a moist crumb without any structure. The eat of sweet pastry whilst hot is soft and paste-like as it cools the texture becomes hard. Unsweetened shortcrust is soft and paste like to eat whilst hot, as it cools it becomes chewy and cloying to the palate.

10. Crumb for Example for Coatings

With food additive X made in accordance with Example 1: From the microwave oven the crumb coated product is allowed to stand for at least 3 minutes to provide stabilisation and the correct eating temperature. Surface crumbed products feel dry over the tops, sides and bottoms. They are firm and not wet or greasy, having a similar nature from the grill or having been heated in a conventional thermal oven. The initial bite or cutting off of a piece of the crumbed product identifies the crumb having a thin crust with crisp edges. Crumb texture is clean and not cloying.

Without food additive X made in accordance with Example 1: From the microwave oven and allowed to stand for at least 3 minutes to cool to the suitable eating temperature. Surfaced crumbed products feel soft, wet and greasy to the touch. The initial bite or cutting off of a piece of the crumbed product reveals the crumb as being soft and wet, like a paste and as it continues to cool the texture becomes rubbery.

11. Batter for Cakes or Puddings and Including Dried or Soft Fruits, Chocolate, Caramel, Fudge, Syrups and Jams

With food additive x made in accordance with Example 1: From the microwave oven the product is allowed to stand for at least 3 minutes to provide stabilisation and the correct consuming temperature. The surfaces tops, sides and bottoms of the product are dry and firm to the touch. They retain their thermal processed appearance. The initial bite or cutting of a slice of the product reveals a clean cut and a moist structural texture with an eating sensation of a product from conventional processing, i.e. the oven, or steam pressure cooking.

Without food additive x made in accordance with Example 1 From the microwave oven the product is allowed to stand for 3 minutes to provide the correct consuming temperature. The surfaces, tops, sides and bottoms tend to be collapsed upon touching due to being wet and greasy. The product is unstable to handle. The initial bite or cutting of a slice of the product is soft, chewy leathery revealing the collapse of the inner structure. Upon cooling it becomes very dry and unpalatable.

12. Chicken, Fish, Pork (Cured and Uncured), Beef, Lamb and Other Fowl, Cheeses Etc. Fritters—Vegetable, Some with Protein.

With food additive X made in accordance with example 1: From the microwave and allowed to stand for at least 3 minutes to provide stabilisation and the correct consuming temperature. The surfaces tops sides and bottoms have the expected appearance of a product prepared in a conventional thermal oven: firm and a crispness to the touch. At the initial bite or cutting off a piece of the product reveals crispness, a textural structure full of succulence and an eating sensation at least equal of a product conventionally prepared.

Without food additive X made typically in accordance with example 1: From the microwave oven and allowed to stand for 3 minutes to provide the correct consuming temperature. The surfaces, tops, sides and bottoms are concave resulting in the loss of juices. The initial bite or cutting off of a piece of the product is firm, chewy toughening leathery textural mouth feel, resulting from the collapse of the structural matrix. The taste is of older meat.

13. Pasta Products:

Using a microwave oven at 800 watts on full power for the time appropriate for the product starting with chilled pasta, frozen pasta or dried pasta mixed with water.

With food additive X made in accordance with example 1 The pasta is taken from the microwave and allowed to stand for at least 3 minutes to provide stabilisation and to allow the pasta to cool to the correct consuming temperature. The surfaces and inner walls of shaped pasta products resemble the appearance expected of pasta cooked conventionally, for example, by steaming boiling, or thermal oven. The pasta is firm but malleable to the touch.

At the initial bite or cutting off of a piece of the pasta, it reveals a texture structure similar to that of conventionally prepared pasta together with a moist tender eating sensation.

Without food additive X made in accordance with example 1 The pasta is taken from the microwave oven and allowed to stand for 3 minutes to allow it to cool to the correct consuming temperature. The surfaces and inner walls of shaped pasta products reveal an uneven appearance, i.e. they are somewhat concave, reflecting uneven cooking and heating.

The initial bite or cutting off of a piece of the pasta is firm, too chewy with a toughening leathery textural mouth feel, resulting from the collapse of the structural moisture retention matrix.

14. Bread: Slices of Buttered Toast, Toasted Sandwiches, Pizza Slices and Rounds, and Bagels.

With food additive made in accordance with example 1 The product is taken from the microwave oven and allowed to stand for at least 3 minutes to provide stabilisation and to allow it to cool to the correct consuming temperature. The bottoms, sides and tops of the product are dry, firm and crisp to the touch. They retain their thermal processed appearance. The initial bite or cutting off of a piece of the product reveals crispness and a light inner easy-to-eat texture, as if fresh from the toaster, grill or conventional thermal oven.

Without food additive X made in accordance with example 1 The product was taken from the microwave oven and allowed to stand for 3 minutes to allow it to cool to the correct consuming temperature. The bottoms, sides, and tops are indented/collapsed, damp to the touch, and unstable to handle. The initial bite or cutting off of a piece of the product is soft, chewy and tough, revealing the collapse of the texture structure through moisture losses.

15. Cakes, Cakes Fruited, Sponges, Sponge Puddings e.g. Chocolate, Syrups, Fruited, Rich Fruited Christmas Puddings, Yorkshire Puddings, Choux Buns and Pastries.

With food additive X made in accordance with example 1: The product was taken from the microwave oven and allowed to stand for at least 3 minutes to provide stabilisation and to allow it to cool to the correct consuming temperature. The surfaces, tops, sides, and bottoms, when turned out of the microbake utensil are firm to the touch, and as expected in appearance. The initial bite or cutting off of a piece reveals the moist structural formation and textural mouth feel sensation, as if direct from conventional thermal processing. Once totally cold the characteristics described are retained.

Without food additive X made in accordance with example 1 The product was taken from the microwave oven and allowed to stand for 3 minutes at least to allow it to cool to the correct consuming temperature. The surfaces appear shrivelled, and tops, sides and bottoms, when turned out of microbake utensil, are much dryer. The initial biting or cutting off of a piece reveals that additional pressure is required to cut. Structure and texture are significantly dryer.

Once totally cold the characteristics described are substantially enhanced yielding a very dry eat.

1-34. (canceled)

35. A food additive composition comprising:
i) bean powder;
ii) water absorbent vegetable fibre;
iii) one or more inorganic calcium compounds; and
iv) modified cellulose,
wherein i) is present in a proportion of between 50 to 90% by weight based on the total weight of i), ii), iii) and iv).

36. A food additive composition as claimed in claim 35 in which the proportion of bean powder present is from 80 to 90% based on the total weight of i), ii), iii) and iv).

37. A food additive composition as claimed in claim 35 wherein the bean powder is lima bean powder.

38. A food additive composition as claimed in claim 35 in which the water absorbent vegetable fibre is present at from 3 to 12% by weight based on the total weight of i), ii), iii) and iv).

39. A food additive composition as claimed in claim 35 in which the water absorbent vegetable fibre is potato fibre.

40. A food additive composition as claimed in claim 35 in which the inorganic calcium compound is present at from 2 to 10% by weight based on the total weight of i), ii), iii) and iv).

41. A food additive composition as claimed in claim 35 in which the inorganic calcium compound is calcium carbonate.

42. A food additive composition as clamed in claim 35 in which the modified cellulose is present at between 0.5 and 10% by weight based on the total weight of i), ii), iii) and iv).

43. A processed food product or food component formulation comprising a food additive composition comprising:
i) bean powder;
ii) water absorbent vegetable fibre;
iii) one or more inorganic calcium compounds; and
iv) modified cellulose,
wherein i) is present in a proportion of between 50 to 90% by weight based on the total weight of i), ii), iii) and iv).

44. A processed food product or food component formulation according to claim 43, wherein the processed food product or food component formulation is selected from the group consisting of all savoury and sweet processed foods, dough based foods and batters (both fermented and non-fermented), inclusive of potato doughs, fillings, toppings, coatings or dustings of dough based foods, batters and potato doughs, including dry crumb coatings and the dusting of such doughs at specific processing steps, puff pastry products, pasta, pies, rolls and slices with both sweet and savoury fillings or toppings, bread, including crusty bread products, baguettes, loaves and rolls (including fillings), garlic bread, soft bread products, fruited buns, hot dog rolls, burger buns, baps and naan bread, pitta bread, tortilla wraps and pizzas, both pizza bases or topped pizzas, batters for Yorkshire pudding, choux buns, various nuggets, fritters, crumpets, cakes, sponge cakes, puddings, potato products, roast potatoes, French fries, potato wedges waffles, potato croquettes and shaped potato products, baked or fried filo pastries, spring rolls, samosas, parcels, morning goods including croissants, Danish pastries, doughnuts, including filled and topped doughnuts, shortcrust pastries, including pies and crumbles (with both sweet and savoury fillings), and bread crumb for coating, crumb coated fish or chicken pieces or products, including shaped fish or chicken products such as fingers or nuggets.

45. A processed food product or food component formulation according to claim 43, wherein the processed food product or food component formulation is selected from the group consisting of a base dough formulation comprising said food additive composition at 0.5% to 5.0%; a base batter formulation comprising said food additive composition at 0.75% to 8.5%; a base potato dough formulation comprising said food additive composition at 0.5% to 3.0%; a filling or topping for a dough product comprising said food additive composition at 1.0% to 5.0%; a processed food comprising said food additive composition as a dusting or coating at 0.1% to 1.5%; a finished or part finished food product comprising said food additive composition in a microwave heatable packaging material; a premix for making a microwave heatable processed food comprising said food additive composition in combination with a base ingredient of a processed food; and a premix for making a microwave heatable processed food comprising said food additive composition in combination with a base ingredient of a processed food in which the base ingredient is flour, and the food additive is present at 1% to 9%.

46. A method of preparing processed foods for heating or cooking in a microwave oven, the method comprising incorporating into a food or ingredient for a food a suitable amount of a food additive composition comprising:
i) bean powder;
ii) water absorbent vegetable fibre;
iii) one or more inorganic calcium compounds; and
iv) modified cellulose,
wherein i) is present in a proportion of between 50 to 90% by weight based on the total weight of i), ii), iii) and iv).

47. A method according to claim 46 in which a suitable amount of food additive composition is from 0.15 to 10% depending on the food product.

48. A method according to claim 46 in which the food additive composition is added to base dough formulations at 0.5% to 5.0%, to base batter formulations at 0.75% to 8.5%, to base potato dough formulations at 0.5% to 3.0%, to fillings/toppings at 1.0% to 5.0%, or to subsequent dough processing steps at 0.1% to 1.5%.

49. A method according to claim 46 in which the food additive ingredient is dusted on the surface of a food to be processed.

50. A method according to claim 46 in which the processed foods are baked or fried, then cooled frozen and packaged.
